(19) United States
(12) Patent Application Publication
(10) Pub. No.: US 2012/0179366 A1
(43) Pub. Date: Jul. 12, 2012

(54) MAP DRAWING DEVICE

(75) Inventor: Shoji Tanaka, Tokyo (JP)

(73) Assignee: Mitsubishi Electric Corporation, Tokyo (JP)

(21) Appl. No.: 13/496,088

(22) PCT Filed: Oct. 27, 2009
(86) PCT No.: PCT/JP2009/005664

§ 371 Date: Mar. 14, 2012

(51) Int. Cl. G01C 21/26; G01C 21/34

(52) U.S. Cl. 701/430; 701/461

(57) ABSTRACT

A map drawing device in accordance with the present invention includes a drawing data converting unit for converting map data acquired from a map database into map data in a data format which can be drawn, and for calculating degrees of importance of map objects each of which is a road, a background face or an icon, a drawing data sorting unit for rearranging the drawing data according to the degrees of importance, and a drawing data management unit for managing the drawing data processed by the drawing data sorting unit. The map drawing device further includes a drawing data cache unit for enabling control to either display or not display each of the map objects according to whether or not the corresponding calculated degrees of importance is equal to or higher than a threshold.

### FIELD OF THE INVENTION

The present invention relates to a map drawing device which draws roads, background faces, and various icons each showing a facility, which are map objects, on a map.

### BACKGROUND OF THE INVENTION

A conventional map drawing device assigns priorities to each road type, to each background face type, and to each icon type, respectively, and performs control to either display or not display each map object according to the priority assigned to this map object. Therefore, assuming that a road A having the lowest priority passes through a hill displayed on an upper left side of a map shown in FIG. 12(a), for example, the road A is erased from the map and then disappears as shown in FIGS. 12(b) and 12(c) when this road having the lowest priority is set to non-display. A problem is, however, that when this road A is erased, the user becomes unable to recognize that the road A passes through the hill, and, even though the road A is connected to another road extending to his or her destination, becomes unable to reach the connection point, unlike in a case in which other roads of the same type in a crowded zone are erased.

A further problem is that because an icon B showing a shop, which is the only one existing along the road A, cannot be discriminated from any other icons B of the same type showing shops existing in a very crowded area, as shown in FIG. 13, the information useful for the user (i.e. the icon B showing the shop which is the only one existing along the road A) is also erased when all of the icons B are collectively changed to a non-display state.

Further, patent reference 1 proposes a technique of reducing the drawing load at the time of scrolling a map by switching from scale map data currently being displayed to scale map data having a smaller scale to display this map when the drawing load increases, as shown in FIGS. 12(a) to 12(c), and 13(a) to 13(b).

### RELATED ART DOCUMENT

### Patent Reference

Patent reference 1: WO 2007/074830

A problem with the technique disclosed by this patent reference 1 is, however, that because the scale map data currently being displayed is suddenly switched to scale map data having a smaller scale, this sudden change of the displayed information of the map confuses the user.

The present invention is made in order to solve the above-mentioned problems, and it is therefore an object of the present invention to provide a map drawing device which can calculate the degrees of importance of each road, each background face, and each of various icons showing a facility, which are map objects, according to both the amounts of visual information which the map objects have, and a current traveling state, and which can draw appropriate map objects depending upon the current conditions on a map according to those degrees of importance.

### SUMMARY OF THE INVENTION

In accordance with the present invention, there is provided a map drawing device including: a drawing data converting unit for converting map data acquired from a map database into map data having a data format which can be drawn to calculate a degree of importance of a road which is a map object, a degree of importance of a background face which is a map object, and a degree of importance of an icon which is a map object, a drawing data sorting unit for rearranging the drawing data according to the degrees of importance, and a drawing data management unit for managing the drawing data processed by the drawing data sorting unit, in which the map drawing device includes a drawing data cache unit for enabling control to either display or not display the road, the background face, and the icon which are the map objects according to whether or not each of the calculated degrees of importance is equal to or higher than a threshold.

Because the map drawing device in accordance with the present invention calculates the degree of importance of a road which is a map object, the degree of importance of a background face which is a map object, and the degree of importance of each of various icons showing a facility which is a map object, and enables control to either display or not display the road, the background face, and each of the icons according to these degrees of importance, the map drawing device can display map objects assumed to be important for the user independently of their types. As a result, for example, the map drawing device in accordance with the present invention can discriminate between a minor street which is the only one existing in a certain area and minor streets existing in a heavily built-up area, such as a residential area, even if they are the same minor streets, and can display only the minor street which is the only one existing in the certain area.

### BRIEF DESCRIPTION OF THE FIGURES

FIG. 1 is a block diagram showing the structure of a map drawing device in accordance with Embodiment 1 of the present invention;

FIG. 2 is a flow chart explaining an outline of the operation of the map drawing device in accordance with Embodiment 1 of the present invention;

FIG. 3 is a flow chart explaining an outline of the operation of the map drawing device in accordance with Embodiment 1 of the present invention;

FIG. 4 is a flow chart explaining in detail the operation of the map drawing device in accordance with Embodiment 1 of the present invention;

FIG. 5 is a data table in which data about each map object is stored for a block corresponding to the coordinates of the map object, the block being one of blocks into which a map region is divided;

FIG. 6 is a table for managing a weight set for each of map object types;

FIG. 7 is a view showing a change in a display screen on which a map object assumed to be important for the user is displayed independently of its type;

FIG. 8 is a view showing a road connected to a route line;

FIG. 9 is a view showing a map region divided into blocks;

FIG. 10 is a view showing a weight depending on the position of an icon according to the distance to an intersection;

FIG. 11 is a view showing a change of a display screen on which map objects assumed to be important for the user are displayed independently of their types;

FIG. 12 is a view showing a change of a display screen on which control to either display or not display a map object is performed on roads and icons according to priorities which are assigned to the roads and the icons according to their types;

FIG. 13 is a view showing a change of a display screen on which icons are collectively changed from a display state to a non-display state while they are discriminated from one another;

FIG. 14 is a view showing a data table for managing thresholds respectively corresponding to four settings of a scroll speed;

FIG. 15 is a view showing a data table for managing thresholds respectively corresponding to CPU load values; and

FIG. 16 is a view showing an algorithm used for determining whether or not an icon is placed on an opposite lane.

### EMBODIMENTS OF THE INVENTION

Hereafter, in order to explain this invention in greater detail, the preferred embodiments of the present invention will be described with reference to the accompanying drawings.

### Embodiment 1

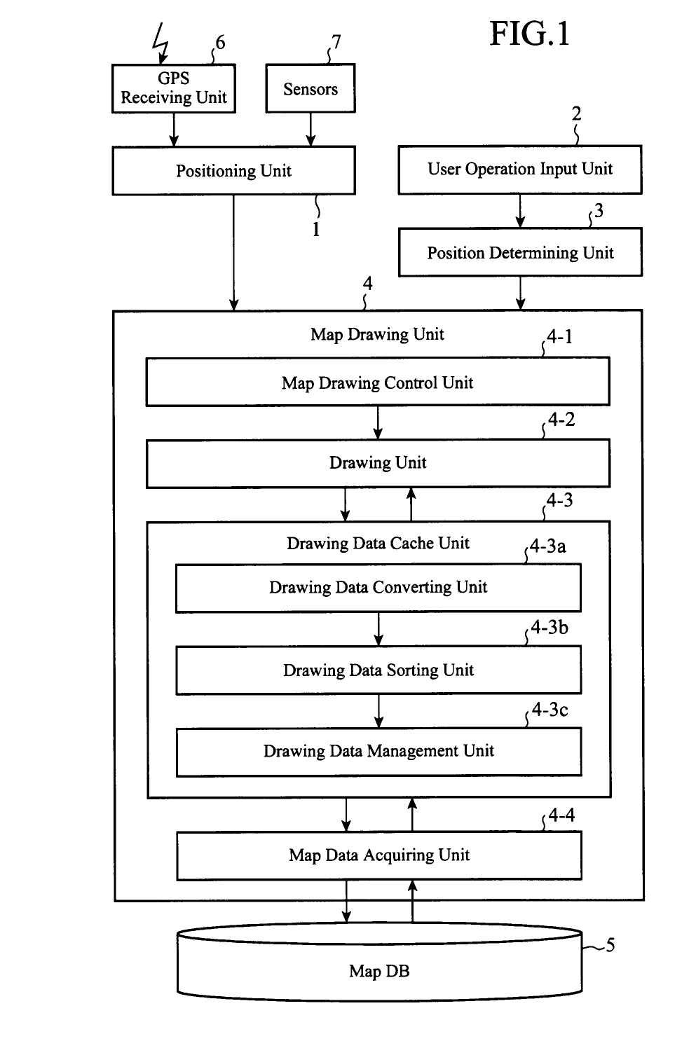

FIG. 1 is a block diagram showing the structure of a map drawing device in accordance with the present invention. This map drawing device is provided with a positioning unit 1, a user operation input unit 2, such as a touch panel, a position determining unit 3, a map drawing unit 4, and a map database (DB) 5.

The positioning unit 1 determines the position of a vehicle according to information, the vehicle speed, etc. from a GPS (Global Positioning System) receiving unit 6 and sensors 7 including a gyro. The user operation input unit 2 accepts information about a user's scroll operation from the touch panel, a remote control, etc. The position determining unit 3 determines a point for which the user desires the map drawing device to display a map according to the user information from the user operation input unit 2. The map drawing unit 4 draws a map centered at the position specified by the positioning unit 1 and the position determining unit 3. The map database 5 stores map data.

The map drawing unit 4 is provided with a map drawing control unit 4-1, a drawing unit 4-2, a drawing data cache unit 4-3, and a map data acquiring unit 4-4. The drawing data cache unit 4-3 includes a drawing data converting unit 4-3a for converting map data acquired by the map data acquiring unit 4-4 into map data in a data format which can be drawn by the drawing unit 4-2, a drawing data sorting unit 4-3b for rearranging drawing data according to degrees of importance, and a drawing data management unit 4-3c for managing the drawing data processed by the drawing data sorting unit 4-3b.

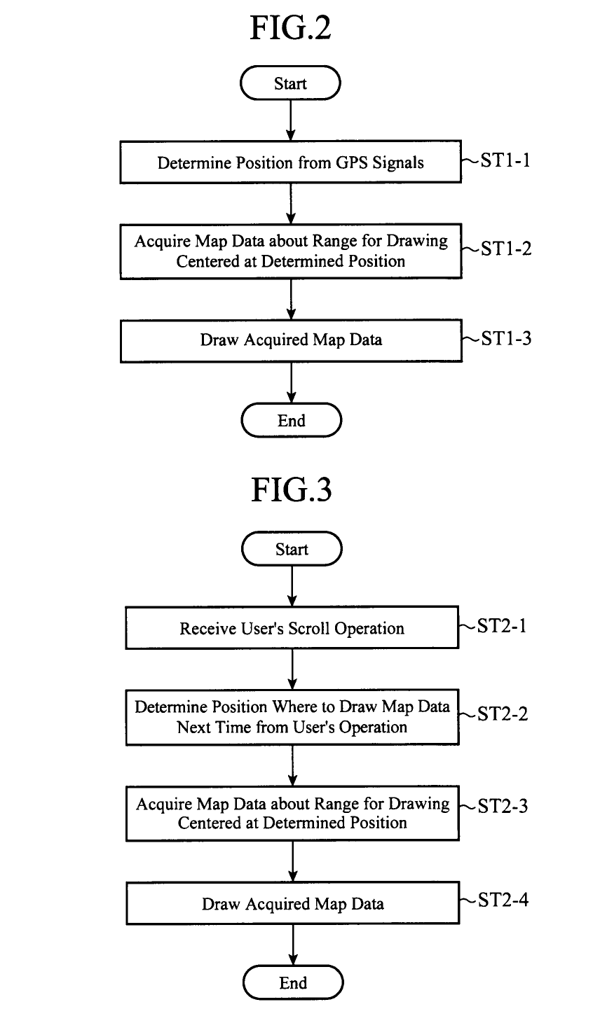

Next, the operation of the map drawing device in accordance with the present invention will be explained with reference to FIGS. 2 to 8. First, the operation of the map drawing device will be explained roughly with reference to flow charts shown in FIGS. 2 and 3. As shown in the flow chart of FIG. 2, when information from the GPS receiving unit 6 or sensor information from the gyro, a speed sensor, and so on is received, the map drawing device determines the position of the vehicle by using the positioning unit 1 first (step ST1-1). The map drawing device then acquires map data about a range for drawing centered at the determined vehicle position from the map database 5 by using the map data acquiring unit 4-4 (step ST1-2), and draws this acquired map data by using the drawing unit 4-2 (step ST1-3).

On the other hand, as shown in the flow chart of FIG. 3, when a scroll operation is received by the user operation input unit 2 (step ST2-1), the map drawing device determines a position which the map drawing device draws map data the next time according to the information from the user operation input unit 2 by using the position determining unit 3 (step ST2-2). The map drawing device acquires map data about a range for drawing centered at the position determined according to the information from the GPS receiving unit 6 or the user operation input unit 2 from the map database 5 via the map data acquiring unit 4-4 (step ST2-3), and draws this acquired map data by using the drawing unit 4-2 (step ST2-4).

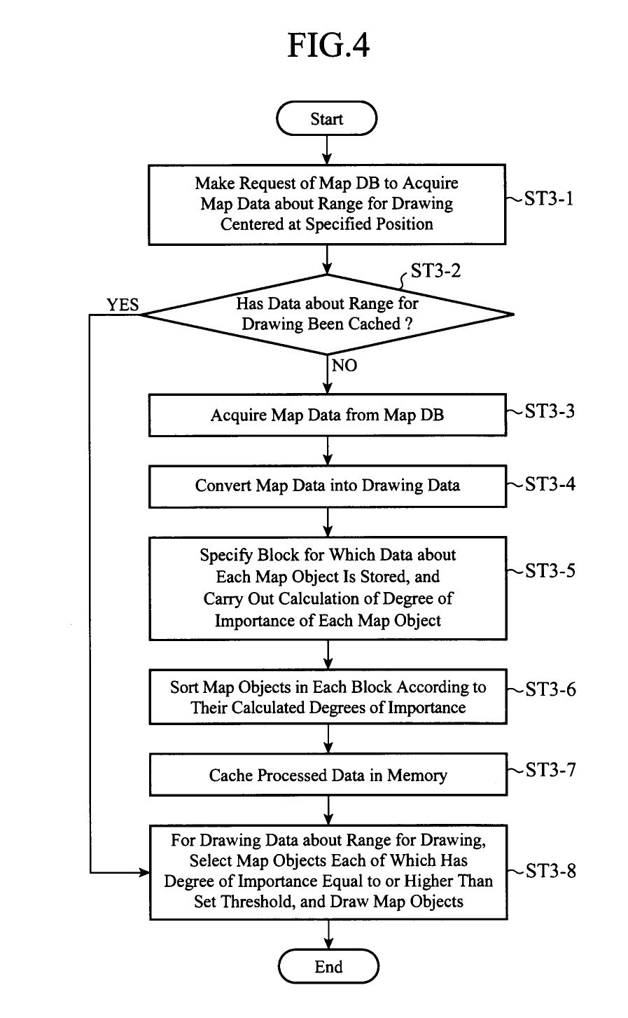

Next, the operation of the map drawing unit 4 will be explained in detail with reference to a flow chart of FIG. 4. When the map drawing unit 4 receives the vehicle position and the scroll center position which are determined by the positioning unit 1 and the position determining unit 3, the map drawing control unit 4-1 issues a map drawing command to the drawing unit 4-2, and the drawing unit 4-2 commands the drawing data cache unit 4-3 to acquire map data about a range for drawing centered at the specified position from the map database 5 (step ST3-1).

The drawing data cache unit 4-3 determines whether it has already cached the map data about the range for drawing (step ST3-2), and, when the result of the determination is NO, acquires the map data from the map database 5 via the map data acquiring unit 4-4 (step ST3-3). Next, the drawing data converting unit 4-3a converts the map data acquired by the drawing data cache unit into data for drawing (step ST3-4). This transforming process is, for example, a process of converting the coordinates in the map data into those in a coordinate system which is used at the time of drawing.

At this time, the drawing data cache unit 4-3 divides drawing data about each region which the drawing data cache unit can acquire from the map database 5 into a plurality of data about smaller blocks (in the illustrated example, sixteen data about 16 blocks), as shown in FIG. 9, to manage the data about each block. The number of blocks included in each region is determined from the size of the region data.

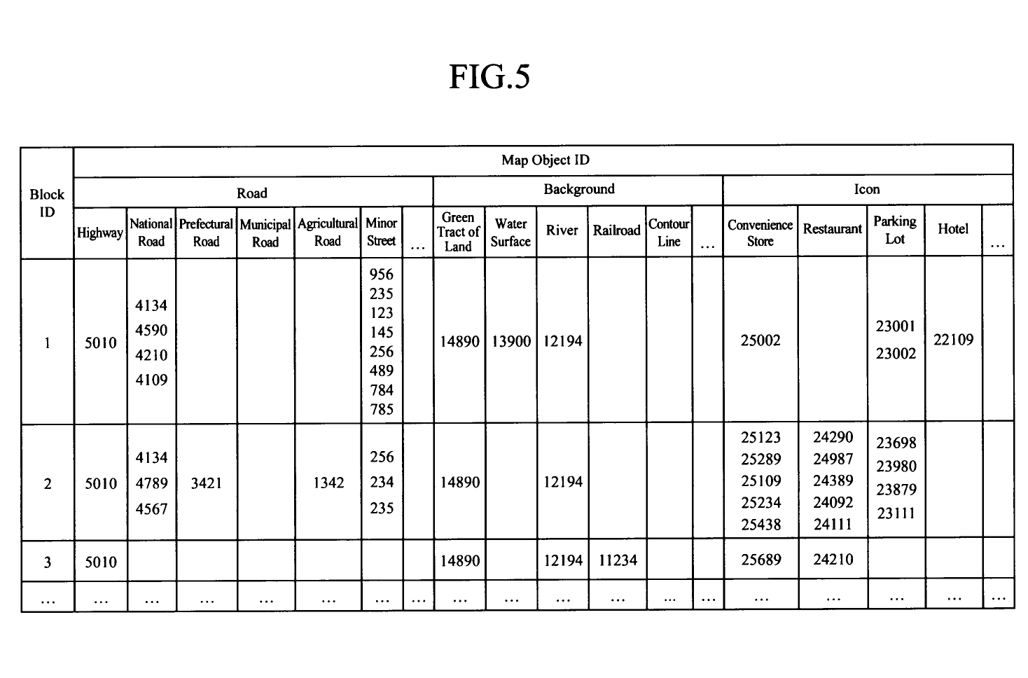

The drawing data converting unit 4-3a stores data about each map object for a block corresponding to the coordinates of the map object, the block being one of blocks into which a region is divided. More specifically, the drawing data converting unit specifies the block for which the drawing data converting unit stores the data about each map object, and carries out calculation of the degree of importance of each map object (step ST3-5). The stored data is managed for each type of map object, for each type, and for each block ID, as shown in FIG. 5. When a map object exists over a plurality of blocks, like a road, the ID of the map object is duplicately stored for the plurality of blocks. FIG. 5 shows that a highway “5010” exists over the blocks 1 to 3, and a national road “4134” exists over the blocks 1 to 2, for example. Further, the same goes for background faces, and FIG. 5 shows that a green tract of land “14890” exists over the blocks 1 to 3, and a river “12194” exists over the blocks 1 to 3, for example.

Next, the map drawing device calculates the degree of importance of each of roads, the degree of importance of each of background faces, and the degree of importance of each of various icons showing a facility, the roads, the background faces and the icons being map objects, according to the following equations.

### [Equation 1]

The degree of importance of a road is given by the following equations.

VE_{R}=bw_{R}·p·l·w_{R}·dw_{R}

bw_{R}=1/n_{R}

where
VE_{R}: the degree of importance of the road,
bw_{R}: the degree of importance of the road in each block,
p: the occurrence probability in blocks,
l: the length of the road,
w_{R}: the weight set for each road type, and
dw_{R}: the weight set for the road which varies dependently upon the traveling state.

### [Equation 2]

The degree of importance of a background face is given by the following equations.

VE_{B}=bw_{B}·p·s·w_{B}·dw_{B}

bw_{B}=1/n_{B}

where
VE_{B}: The degree of importance of the background face,
bw_{B}: The degree of importance of the background face in each block,
p: the occurrence probability in blocks,
s: the area of the background face,
w_{B}: the weight set for each background face type, and
dw_{B}: the weight set for the background face which varies dependently upon the traveling state.

### [Equation 3]

The degree of importance of an icon is given by the following equations.

VE_{B}=bw_{B}·p·s·w_{B}·dw_{B}

bw_{B}=1/n_{B}

where
VE_{I}: the degree of importance of the icon,
bw_{I}: the degree of importance of the icon in each block,
Iw_{I}: the weight according to the position of the icon,
w_{I}: the weight set for each icon type, and
dw_{I}: the weight set for the icon which varies dependently upon the traveling state.

In this case, the degree of importance of a road in each block, the degree of importance of a background face in each block, and the degree of importance of an icon in each block are acquired by carrying out normalization by using the total number of roads in each block shown in above-mentioned FIG. 9, the total number of background faces in each block, and the total number of icons in each block, respectively, as shown in the equation 1, the equation 2, and the equation 3.

The occurrence probability in blocks shows to how many blocks included in all the blocks which are the target for calculation of the degree of importance the road or the background face belongs.

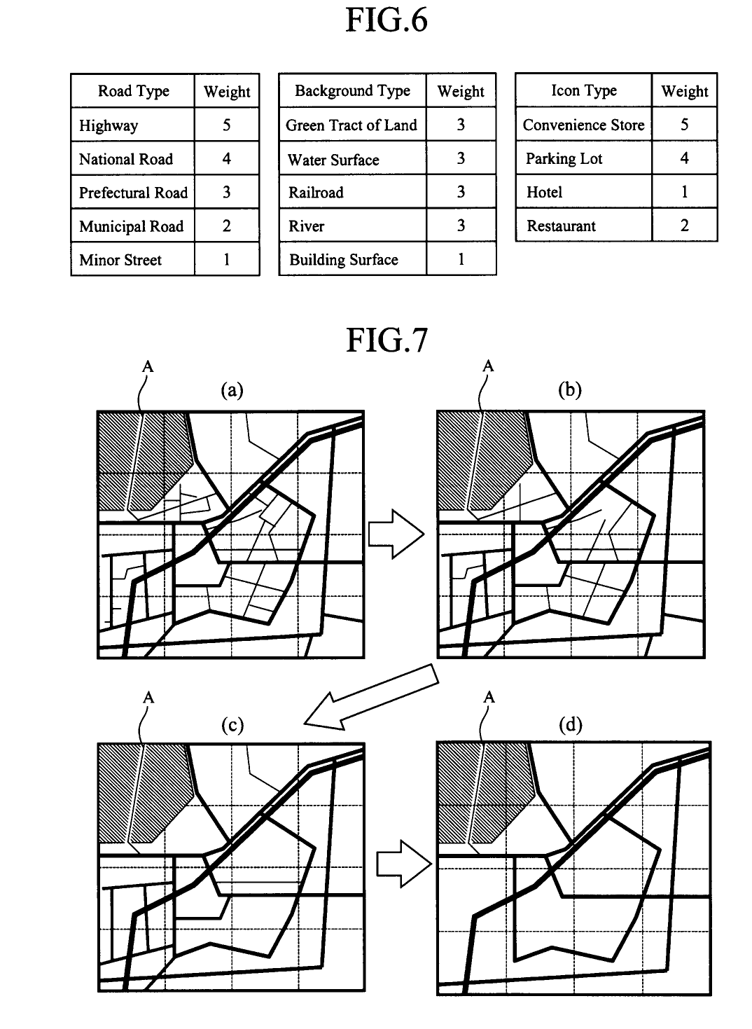

Further, the weights set for types of roads, types of background faces, and types of icons which are map objects, are managed by using a table as shown in FIG. 6. As shown in FIG. 6, even though map objects belong to the same category of roads, the weight set for each of the map objects changes according to its road type such as highway, national road, prefectural road, municipal road, or minor street. Similarly, even though map objects belong to the same category of background faces, the weight set for each of the map objects changes according to its background face type, such as green tract of land, water surface, railroad, river, or building surface. Similarly, even though map objects belong to the same category of icons, the weight set for each of the map objects changes according to its icon type, such as convenience store, parking lot, hotel, or restaurant.

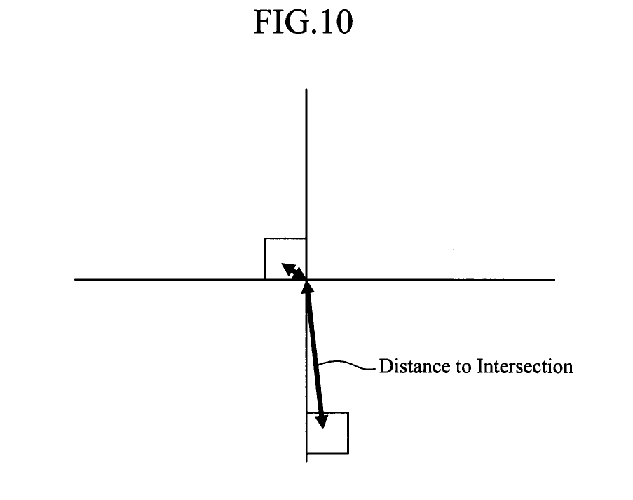

Next, the weight set for an icon and depending on its position is determined according to, for example, the distance to an intersection, as shown in FIG. 10.

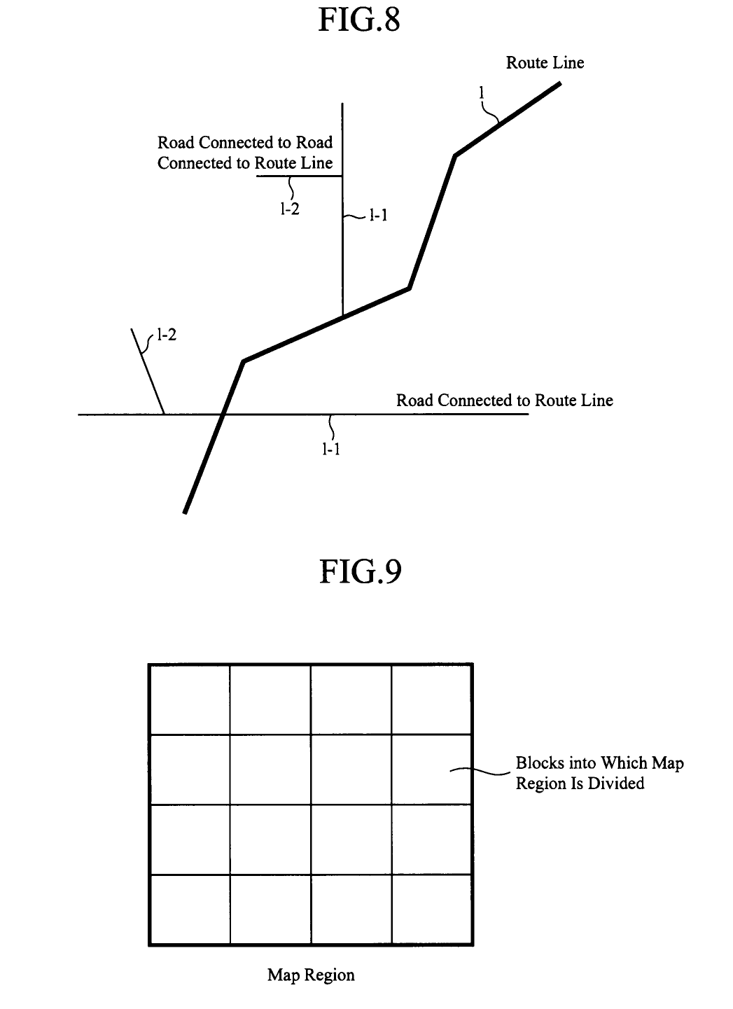

The weight which varies dependently upon the traveling state is defined as follows. For example, in the case of a road, the weight which varies dependently upon the traveling state is set according to whether or not the road is a route line 1, whether or not the road is a one 1-1 connected to the route line 1, and whether or not the road is a one 1-2 which is further connected to a road 1-1 connected to the route line 1, as shown in FIG. 8. In the case of a background face or an icon, the weight which varies dependently upon the traveling state is determined by the distance from the route line 1.

The drawing data sorting unit 4-3b sorts the map objects in each block according to the degrees of importance calculated as above (step ST3-6), and the map drawing device caches the data processed by the drawing data management unit 4-3c in a memory (step ST3-7).

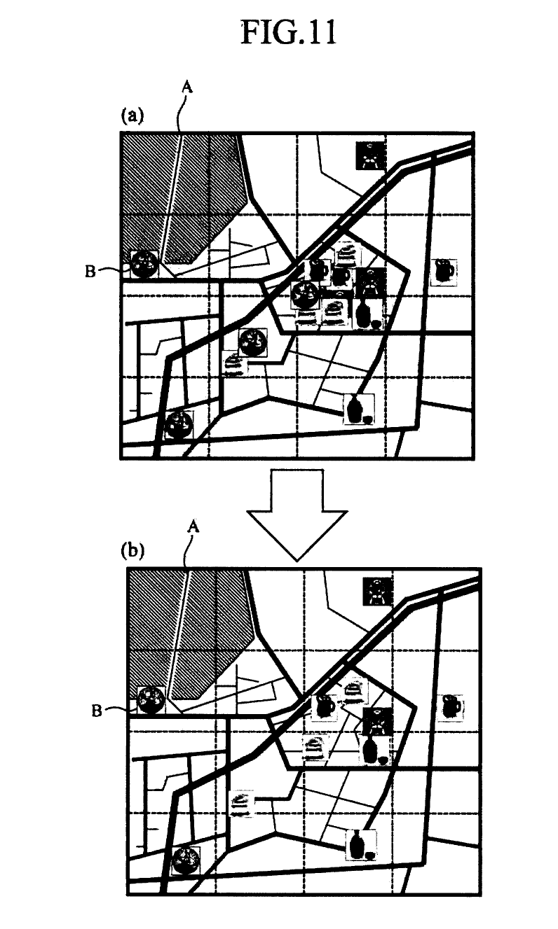

For the drawing data about the range for drawing, the drawing unit 4-2 selects the map objects each of which has a degree of importance equal to or higher than the set threshold from the drawing data cached above, and draws the map objects (step ST3-8). More specifically, a road A or icons B having a higher degree of importance are displayed as shown in FIGS. 7 and 11 even if roads or icons having a lower degree of importance which belong to the same category as that to which the road A or icons B belong are changed to a non-display state. When the result of the determination of step ST3-2 is YES, the map drawing device shifts to step ST3-8, and the drawing unit selects the map objects each of which has a degree of importance equal to or higher than the set threshold from the drawing data cached above for the drawing data about the range for drawing, and draws the map objects.

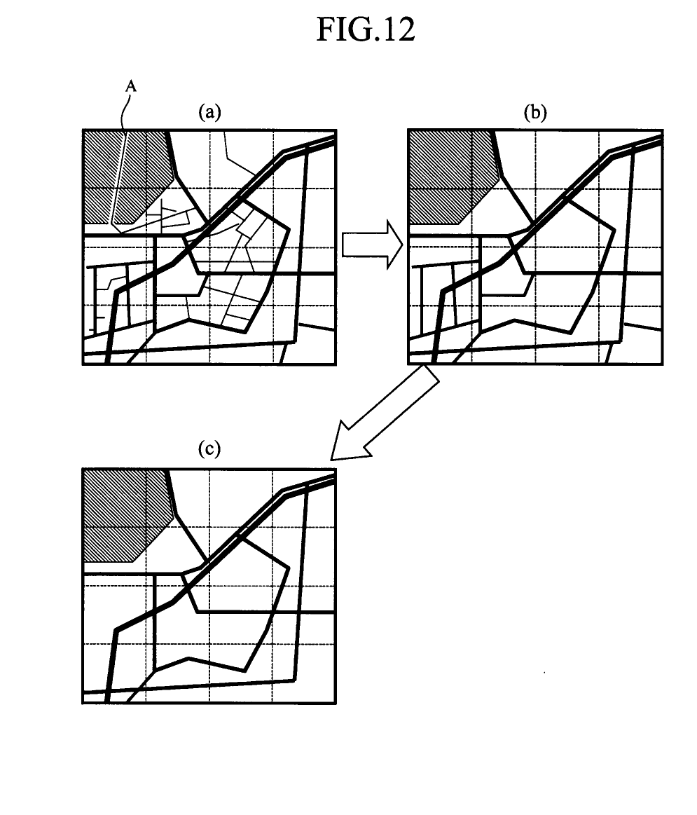

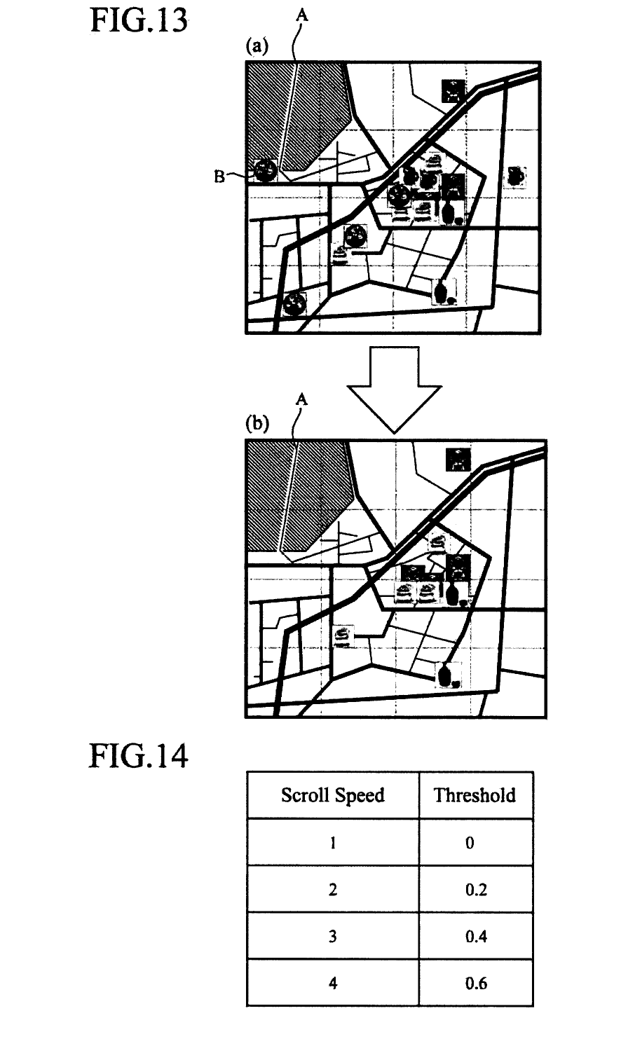

As mentioned above, as compared with a conventional case in which a display or non-display process is performed only according to types, such as road types, background face types, or icon types, as shown in FIGS. 12 and 13, the map drawing device in accordance with Embodiment 1 controls the display or non-display process according to whether or not each of the degree of importance of each road determined through the arithmetic operation using the above-mentioned equation 1, the degree of importance of each background face determined through the arithmetic operation using the above-mentioned equation 2, and the degree of importance of each icon determined through the arithmetic operation using the above-mentioned equation 3 is equal to or higher than the threshold, as shown in FIG. 7 or FIG. 11. Therefore, the map drawing device in accordance with this embodiment can keep roads, background faces, and icons which are map objects assumed to be important for the user displayed independently of their types.

### Embodiment 2

Although the map drawing device in accordance with Embodiment 1, in step ST3-8, filters the drawing data by using the fixed threshold, the map drawing device can alternatively change the threshold according to a scroll speed.

For example, as shown in FIG. 14, when the scroll speed is set to one of four settings, a threshold corresponding to each of the four scroll speed settings is managed by using a table, and the drawing unit 4-2 can change the threshold according to the scroll speed to filter the map data.

As mentioned above, the map drawing device in accordance with Embodiment 2 can display a map which gradually changes to a rough one as the scroll speed increases. Further, unlike conventional map drawing devices, the map drawing device in accordance with this embodiment can scroll the map while keeping as many map objects important for the user as possible displayed.

### Embodiment 3

Although the map drawing device in accordance with Embodiment 2 changes the threshold according to the scroll speed to draw the map, the map drawing device can alternatively change the threshold according to the drawing load imposed on the system.

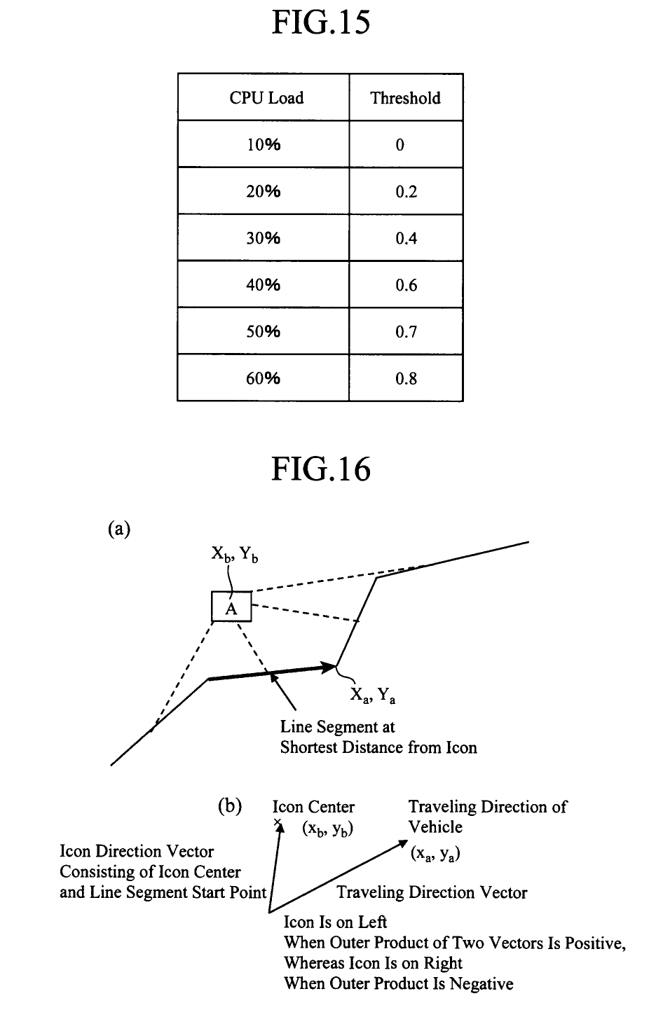

For example, as shown in FIG. 15, the map drawing device in accordance with this embodiment can manage thresholds respectively corresponding to possible values of the CPU load at the time of drawing by using a table, and the drawing processing unit 4-2 can change the threshold according to the CPU load to filter the map data.

As mentioned above, the map drawing device in accordance with Embodiment 3 can stabilize the drawing update cycle by displaying a rough map when the drawing load is high. Further, unlike conventional map drawing devices, the map drawing device in accordance with this embodiment can draw the map while keeping as many map objects important for the user as possible displayed. Instead of the CPU load, the load imposed on the H/W for drawing can be defined as the drawing load.

### Embodiment 4

Although the distance from the vehicle position is not taken into consideration for the calculation of the degree of importance of each map object in Embodiment 1, the degree of importance of each map object can be changed according to the distance from the vehicle position.

What is necessary is to multiply the equation 1, the equation 2, and the equation 3 by weights dist_{R}, dist_{R} and dist_{I} depending on the distance from the vehicle position, respectively, to calculate the degree of importance.

### [Equation 4]

The degree of importance of a road is given by the following equation.

VE_{R}=bw_{R}·p·l·w_{R}·dw_{R}

### [Equation 5]

The degree of importance of a background face is given by the following equation.

VE_{B}=bw_{B}·p·s·w_{B}·dw_{B}

### [Equation 6]

The degree of importance of an icon is given by the following equation.

VE_{I}=bw_{I}·Iw·w_{I}·dist_{I}·dw_{I}

As mentioned above, because the map drawing device according to this Embodiment 4 changes the degree of importance according to the distance from the vehicle position, the map drawing device can draw map objects assumed to be important for the user independently of their types.

### Embodiment 5

Although the weight which varies dependently upon the traveling state in the case of a road is set according to whether or not the road is a one 1 on the route line, a one 1-1 connected to the route line, a road 1-2 connected to a road connected to the route line, or another road other than those roads, as shown in FIG. 8, in Embodiment 1, when the vehicle is travelling along a highway, for example, the weight which is set for a road and which varies dependently upon the traveling state can be changed according to whether or not the road is connected to an interchange of the highway.

As mentioned above, because when the vehicle is travelling along a highway, for example, the map drawing device according to this Embodiment 5 can change the weight which is set for a road and which varies dependently upon the traveling state according to whether or not the road is connected to an interchange of the highway, the map drawing device in accordance with this embodiment can display map objects on the map while keeping as many map objects important for the user as possible displayed independently of their types.

### Embodiment 6

Although the map drawing device in accordance with Embodiment 1 changes the weight which varies dependently upon the traveling state in the case of an icon according to the distance from the route line 1, the map drawing device can alternatively change the weight according to whether the icon is on either a driving lane or an opposite lane, for example.

FIG. 16 is a view showing an algorithm used for determining whether or not an icon is on an opposite lane. In order to determine the direction of each of all icons in the map currently being displayed, the distance between each of all the icons and each line segment of the road along which the vehicle is travelling is determined first to determine the shortest line segment. This calculation can be performed at a high speed by using, for example, the distance between the middle point of each line segment and each of the icons.

Next, a traveling direction vector (xₐ, yₐ) corresponding to the traveling direction of the vehicle is determined from the determined line segment. An icon direction vector (x_{b}, y_{b}) which consists of both the coordinates of the center of each of the icons and the start point of the traveling direction vector is also determined. Next, the outer product (=xₐy_{b}−x_{b}yₐ) of these two vectors is calculated to determine whether or not this outer product is equal to or larger than zero. When the outer product is negative, it can be seen that the icon is placed on the right-hand side of the road, and this icon faces the opposite lane.

As mentioned above, the map drawing device in accordance with Embodiment 6 adjusts the weight for an icon placed on an opposite lane, i.e. an icon showing something which it is difficult for the user to reach in light of the present circumstances to change the icon placed on the opposite lane unnecessary for the user to a non-display state.

### Embodiment 7

Although the map drawing device in accordance with Embodiment 1 carries out table management of the weight for each type, as shown in FIG. 6, the map drawing device can change the weight for each road type according to, for example, road information, such as traffic stop, no entry, a speed limit, or no right or left turn, or traffic information, such as traffic congestion, accident, tire chain restriction, or driving time restriction.

As mentioned above, because the map drawing device in accordance with embodiment 7 changes the weight for each road type according to road information or traffic information, the map drawing device can display roads on the map while keeping as many roads important for the user as possible displayed, and can change roads unnecessary for the user to a non-display state.

### Embodiment 8

Although the map drawing device in accordance with Embodiment 1 carries out table management of the weight for each type, as shown in FIG. 6, the map drawing device can change the weight for each icon type according to, for example, facility attribution information, such as whether or not there is a parking lot, whether or not there is a parking space, whether or not there is an ATM machine, whether or not there is a toilet, or whether or not an event is being held.

As mentioned above, because the map drawing device in accordance with Embodiment 8 changes weight for each icon type according to facility attribution information, the map drawing device can display icons on the map while keeping as many icons important for the user as possible displayed, and can change roads unnecessary for the user to a non-display state.

### Embodiment 9

Although the map drawing device in accordance with Embodiment 1 carries out table management of the weight for each type, as shown in FIG. 6, the map drawing device can change the weight for each icon type according to the degree of complexity of arrival to each icon by calculating, for example, the number of times that the vehicle makes a right or left turn while the vehicle travels from the current position to the position shown by the icon.

As mentioned above, because the map drawing device in accordance with Embodiment 9 changes the weight for each icon type according to the degree of complexity of arrival to each icon, the map drawing device can display icons on the map while keeping as many icons important for the user as possible displayed, and can change icons unnecessary for the user to a non-display state.

### Embodiment 10

Although the map drawing device in accordance with Embodiment 1 carries out table management of the weight for each type, as shown in FIG. 6, the map drawing device can calculate the time required for the vehicle to reach a position shown by an icon from the current position, for example, and can change the weight for each icon type according to this time required for the vehicle to reach the position.

As mentioned above, because the map drawing device in accordance with Embodiment 9 changes the weight for each icon type according to the time required for the vehicle to reach a position shown by an icon, the map drawing device can display icons on the map while keeping as many icons important for the user as possible displayed, and can change icons unnecessary for the user to a non-display state.

### INDUSTRIAL APPLICABILITY

This map drawing device is suitable for use as a map drawing device which displays roads, background faces, and various icons each showing a facility which are map objects and which are necessary for the user on the map while changing map objects unnecessary for the user to a non-display state.

1. A map drawing device comprising:
a positioning unit for determining a position of a vehicle according to information inputted from outside the map drawing device;
a position determining unit for determining a point which a user desires said map drawing device to display a map according to information about the user's operation;
a map drawing unit for drawing a map centered at the position determined by said positioning unit and said position determining unit; and
a map database for storing map data, wherein
said map drawing unit includes a drawing data converting unit for converting map data acquired from said map database into map data having a data format which can be drawn to calculate a degree of importance of a road which is a map object, a degree of importance of a background face which is a map object, and a degree of importance of an icon which is a map object, a drawing data sorting unit for rearranging said drawing data according to the degrees of importance, and a drawing data management unit for managing the drawing data processed by said drawing data sorting unit, and said map drawing device includes a drawing data cache unit for enabling control to either display or not display the road, the background face, and the icon which are said map objects according to whether or not each of the calculated degrees of importance is equal to or higher than a threshold.

2. The map drawing device according to claim 1, wherein the degree of importance of the road is determined from a degree of importance in each block of the road, occurrence probability in blocks of the road, a length of the road, a weight set for each road type, and a weight set for the road which varies dependently upon a traveling state.

3. The map drawing device according to claim 2, wherein the weight set for each road type is changed according to road information or traffic information.

4. The map drawing device according to claim 1, wherein the degree of importance of the background face is determined from a degree of importance in each block of the background face, occurrence probability in blocks of the background face, an area of the background face, a weight set for each background face type, and a weight set for the background face which varies dependently upon a traveling state.

5. The map drawing device according to claim 1, wherein the degree of importance of the icon is determined from a degree of importance in each block of the icon, occurrence probability in blocks of the icon, a weight according to a position of the icon, a weight set for each icon type, and a weight set for the icon which varies dependently upon a traveling state.

6. The map drawing device according to claim 5, wherein the weight set for each icon type is changed according to facility attribution information.

7. The map drawing device according to claim 1, wherein when determining the degree of importance of the road, the map drawing device changes a weight according to whether the road is a route line, a one connected to a route, a one connected to a road connected to the route, or another road other than those roads.

8. The map drawing device according to claim 1, wherein when determining the degree of importance of the background face, the map drawing device changes a weight according to a distance from a route line.

9. The map drawing device according to claim 1, wherein when determining the degree of importance of the icon, the map drawing device changes a weight according to a distance from a route line.

10. The map drawing device according to claim 1, wherein the map drawing device changes the threshold with which to change the display or non-display of each map object according to a scroll speed.

11. The map drawing device according to claim 1, wherein the map drawing device changes the threshold with which to change the display or non-display of each map object according to a drawing processing load imposed on a system.

12. The map drawing device according to claim 1, wherein the map drawing device changes a weight according to a distance from the position of the vehicle.

13. The map drawing device according to claim 1, wherein when the vehicle is travelling along a highway, the map drawing device sets a weight to the road according to whether or not the road is connected to an interchange of the highway.

14. The map drawing device according to claim 1, wherein the map drawing device sets a weight to the icon according to whether the icon is placed on either a travelling lane or an opposite lane.
